(19) United States
(12) Patent Application Publication
(10) Pub. No.: US 2018/0180977 A1
(43) Pub. Date: Jun. 28, 2018

(54) PROJECTOR

(71) Applicant: Shenzhen China Star Optoelectronics Technology Co., Ltd., Shenzhen, Guangdong (CN)

(72) Inventor: Xiangyang Xu, Shenzhen, Guangdong (CN)

(73) Assignee: Shenzhen China Star Optoelectronics Technology Co., Ltd., Shenzhen, Guangdong (CN)

(21) Appl. No.: 15/324,489

(22) PCT Filed: Sep. 28, 2016
(86) PCT No.: PCT/CN2016/100590

§ 371 Date: Jan. 6, 2017

(30) Foreign Application Priority Data
Aug. 22, 2016 (CN) 201610698752.9

(51) Int. Cl. G03B 21/20; G03B 21/00; G02B 27/10; G02B 27/14; G03B 33/12

(52) U.S. Cl. CPC G03B 21/2053; G03B 21/208; G03B 21/2073; G03B 33/12; G02B 27/102; G02B 27/14; G03B 21/006

(57) ABSTRACT

Disclosed is a projector, which includes a light source; a focusing lens on one side of the light source; a switching wheel configured to alternately block or transmit light formed by the focusing lens, and located on one side of the focusing lens, wherein time for blocking light formed by the focusing lens is less than or equal to time for transmitting light formed by the focusing lens; a linearly polarized light synthesis component configured to form light transmitted through the switching wheel into linearly polarized light, and located on one side of the switching wheel; an optical separation modulator configured to separate the linearly polarized light into light in a plurality of colors and modulate the light in a plurality of colors, and located on one side of the linearly polarized light synthesis component; a beam combining mirror configured to converge the modulated light in a plurality of colors; and a projection lens provided on one side of the beam combining mirror.

### CROSS-REFERENCE TO RELATED APPLICATIONS

This application claims the priority of Chinese patent application CN 201610698752.9, entitled “Projector” and filed on Aug. 22, 2016, the entirety of which is incorporated herein by reference.

### FIELD OF THE INVENTION

The present disclosure relates to the technical field of image processing, and in particular, to a projector.

### BACKGROUND OF THE INVENTION

A conventional projector is only used on office occasions, and generally only displays still images, so that a “smear” phenomenon caused by a slow liquid crystal response speed in an LCD/LCoS chip and a visual persistence phenomenon owned by human eyes does not occur to motion pictures. However, in recent years, projectors have been started to be used in home cinemas. If a projection chip used in a home cinema is an LCD/LCoS chip, the “smear” phenomenon that occurs due to dynamic images is more severe than a case in which a DMD chip is used. However, although the DMD chip responses fast, due to the visual persistence phenomenon of human eyes, the “smear” phenomenon of a dynamic image cannot be fundamentally removed only by improving a response speed.

The “smear” phenomenon is mainly caused by two reasons. The first reason is that it takes some time for a liquid crystal to respond. An intermediate state of liquid crystal molecules exists during switchover between a previous image and a next image, and the intermediate state causes blur of images. The second reason is that human eyes have a visual persistence effect. Time in which an image remains on a retina of a human eye is 10 to 12 ms. In this way, a first image is overlapped with a second image, and consequently, image blur is caused.

Currently, there are two ways to eliminate “smear” from a liquid crystal panel. The first way is to improve a refresh frequency, e.g., to double an original refresh frequency and insert a black image between two original frames (i.e., black frame insertion). The other way is to insert a black image between two frames by switching off a backlight source.

The backlight source is switched off and the black image is inserted for two objectives. The first objective is that an image is not displayed when liquid crystal molecules are in an intermediate state between a first frame and a second frame, so that the liquid crystal molecules located in the intermediate state do not display an image. The second objective is to cut off visual persistence of the first frame on a retina of a human eye. The visual persistence can be cut off by superposing a black image on an image of the first frame.

To eliminate the “smear” phenomenon, it is necessary to provide a new projector.

### SUMMARY OF THE INVENTION

To solve the foregoing problem, the present disclosure provides a projector, which has a simple structure. In projection display, the projector can eliminate the “smear” phenomenon by using a simple method, so as to improve image quality, and improve viewing experience effects.

To achieve the foregoing objective, the present disclosure provides a projector, wherein the projector comprises:

a light source;

a focusing lens provided on one side of the light source;

a switching wheel configured to alternately block or transmit light formed by the focusing lens, wherein time for blocking light formed by the focusing lens is less than or equal to time for transmitting light formed by the focusing lens, and the switching wheel is provided on one side, away from the light source, of the focusing lens;

a linearly polarized light synthesis component configured to form light transmitted through the switching wheel into linearly polarized light, wherein the linearly polarized light synthesis component is provided on one side, away from the focusing lens, of the switching wheel;

an optical separation modulator configured to separate the linearly polarized light into light in a plurality of colors and modulate the separated light in a plurality of colors, wherein the optical separation modulator is provided on one side, away from the switching wheel, of the linearly polarized light synthesis component;

a beam combining mirror configured to converge the modulated light in a plurality of colors and form outgoing light; and

a projection lens provided on one side, away from the optical separation modulator, of the beam combining mirror.

In the projector as described above, the linearly polarized light synthesis component comprises:

a polarized light converter provided on one side, away from the focusing lens, of the switching wheel,

wherein a plurality of shaping optical elements are provided between the polarized light converter and the switching wheel.

In the projector as described above, the optical separation modulator comprises an optical separator configured to separate first light, second light, and third light; and a first optical modulator, a second optical modulator, and a third optical modulator that respectively modulate the first light, the second light, and the third light.

In the projector as described above, the optical separator comprises a first dichroscope and a second dichroscope. The first dichroscope is provided in an inclined manner and is located on one side, away from the switching wheel, of the linearly polarized light synthesis component, and the second dichroscope is provided parallel to the first dichroscope and is located on one side, away from the linearly polarized light synthesis component, of the first dichroscope.

In the projector as described above, the first optical modulator is a first optical modulation LCD chip; a first reflecting mirror parallel to the first dichroscope is provided above the first dichroscope; and the first optical modulation LCD chip is provided on one side, close to the second dichroscope, of the first reflecting mirror.

In the projector as described above, the second optical modulator is a second optical modulation LCD chip, which is located above the second dichroscope; a second reflecting mirror parallel to the second dichroscope is provided on one side, away from the first dichroscope, of the second dichroscope; a third reflecting mirror staggered with the second reflecting mirror is provided above the second reflecting mirror, and light formed by reflection of the third reflecting mirror is parallel to light incident on the second reflecting mirror; a third optical modulation LCD chip parallel to the first optical modulation LCD chip is provided on one side, close to the second dichroscope, of the third reflecting mirror; the second optical modulation LCD chip is disposed between the first optical modulation LCD chip and the third optical modulation LCD chip, and is perpendicular to the first optical modulation LCD chip; the beam combining mirror is provided above the second optical modulation LCD chip and is located between the first optical modulation LCD chip and the third optical modulation LCD chip.

In the projector as described above, the first optical modulator comprises a first optical modulation Lcos chip located above the beam combining mirror and a first polarized beam combining mirror provided between the first optical modulation Lcos chip and the beam combining mirror, and a first reflecting mirror parallel to the first dichroscope is provided on one side, close to the first dichroscope, of the first polarized beam combining mirror.

In the projector as described above, the second optical modulator comprises: a second optical modulation Lcos chip provided on one side, close to the second dichroscope, of the beam combining mirror, and a second polarized beam combining mirror provided between the second optical modulation Lcos chip and the beam combining mirror and located above the second dichroscope; and the third optical modulator comprises: a third optical modulation Lcos chip located below the beam combining mirror, and a third polarized beam combining mirror provided between the third optical modulation Lcos chip and the beam combining mirror and located on one side, away from the first dichroscope, of the second dichroscope.

In the projector as described above, the switching wheel comprises a plurality of black areas configured to block light, and a transparent area or blank area for light to pass through which is provided between adjacent two of the black areas, wherein an area of the black area is less than or equal to that of the transparent area or the white area.

In the projector as described above, the switching wheel comprises a translational device, and a blocking sheet that moves left and right on the translational device to block or transmit light.

In projection display, the projector of the present disclosure eliminates the “smear” phenomenon by using a simple method, and at the same time, can reduce the “smear” phenomenon caused by a slow liquid crystal response speed in an LCD/LCoS chip (including a DMD chip with a fast response speed) and a visual persistence phenomenon of human eyes, so as to improve image quality and viewing experience effects.

### BRIEF DESCRIPTION OF THE DRAWINGS

The present disclosure will be described in a more detailed way below based on embodiments and with reference to the accompanying drawings, in which:

FIG. 1 is a diagram (I) of a projector of the present disclosure;

FIG. 2 is a diagram (II) of a projector of the present disclosure;

FIG. 3 is a structural diagram (I) of a switching wheel of a projector of the present disclosure;

FIG. 4 is a structural diagram (II) of a switching wheel of a projector of the present disclosure;

FIG. 5 is a diagram of first state of a structural diagram (III) of a switching wheel of a projector of the present disclosure;

FIG. 6 is a diagram of second state of the structural diagram (III) of a switching wheel of a projector of the present disclosure;

FIG. 7 is a diagram of third state of the structural diagram (III) of a switching wheel of a projector of the present disclosure; and

FIG. 8 is a diagram of a relationship between a rotation speed of a switching wheel and a switching frequency of chip liquid crystal of the present disclosure.

In the accompanying drawings, same components use same reference signs. The accompanying drawings are not drawn according to actual proportions.

### DETAILED DESCRIPTION OF THE EMBODIMENTS

Details of the present disclosure can be known more clearly with reference to the accompanying drawings and description of specific embodiments of the present disclosure. However, specific embodiments of the present disclosure that are described herein are used only to explain the present disclosure, and cannot be understood, in any manner, as a limitation to the present disclosure. In light of the teaching of the present disclosure, a person skilled in the art can envision any possible deformation based on the present disclosure, which should be considered to fall into the scope of the present disclosure. The present disclosure is further described below with reference to the accompanying drawings.

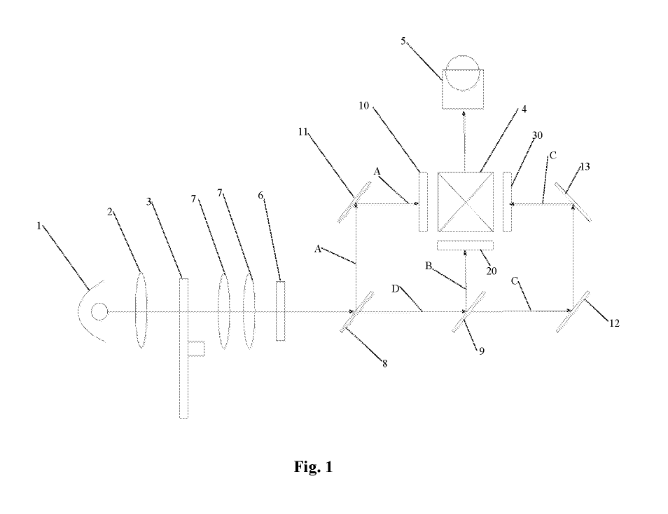

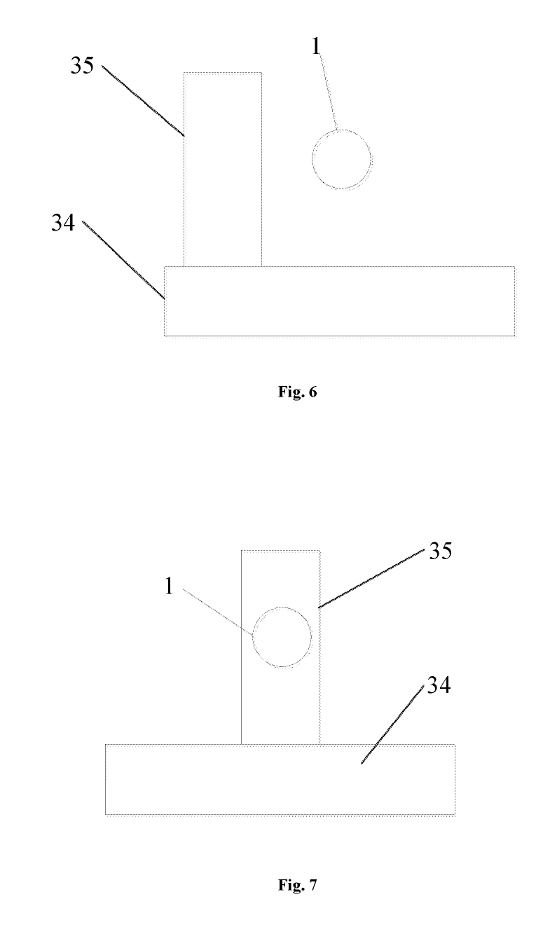

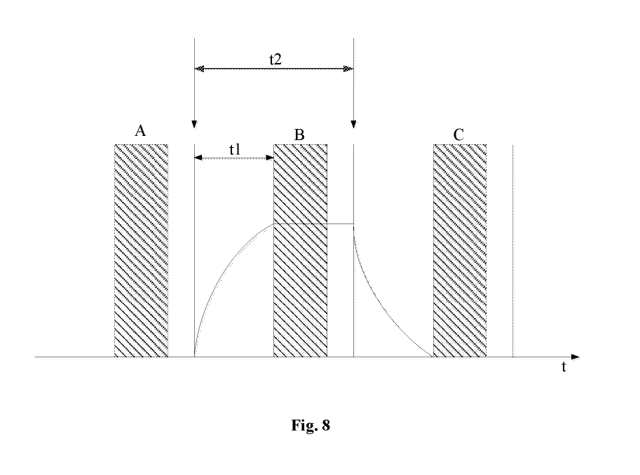

FIG. 1 to FIG. 8 are respectively a diagram (I) of a projector of the present disclosure, a diagram (II) of a projector of the present disclosure, a structural diagram (I) of a switching wheel of the present disclosure, a structural diagram (II) of a switching wheel of the present disclosure, a diagram of first state of a structural diagram (III) of a switching wheel of the present disclosure, a diagram of second state of the structural diagram (III) of a switching wheel of the present disclosure, a diagram of third state of the structural diagram (III) of a switching wheel of the present disclosure, and a diagram of a relationship between a rotation speed of a switching wheel and a switching frequency of chip liquid crystal of the present disclosure.

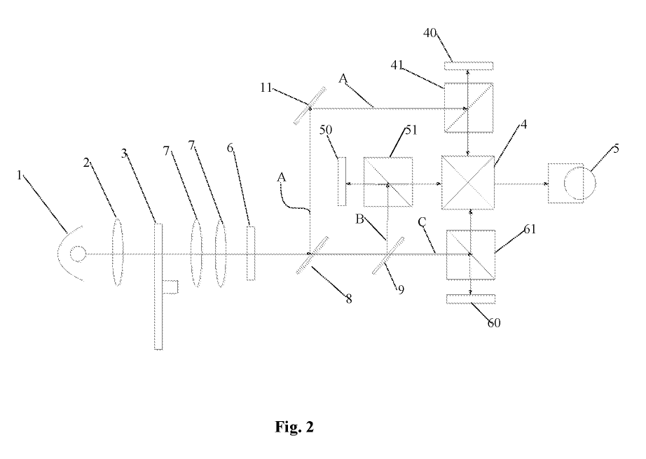

As shown in FIG. 1 and FIG. 2, the projector of the present disclosure comprises: a light source 1, a focusing lens 2, a switching wheel 3, a linearly polarized light synthesis component, an optical separation modulator, a beam combining mirror 4, and a projection lens 5. The focusing lens 2 is provided on one side of the light source 1. The switching wheel 3 can alternately block and transmit light that passes through the focusing lens 2. That is, light that passes through the focusing lens 2 is blocked by the switching wheel 2 and passes through the switching wheel 3 alternately, and time for blocking light formed by the focusing lens 2 is less than or equal to time for transmitting light formed by the focusing lens 2. The switching wheel 3 is provided on one side, away from the light source 1, of the focusing lens 2. The linearly polarized light synthesis component can form light transmitted through the switching wheel into linearly polarized light. The linearly polarized light synthesis component is provided on one side, away from the focusing lens 2, of the switching wheel 3. The optical separation modulator is configured to separate the linearly polarized light into light in a plurality of colors and modulate the separated light in a plurality of colors. The optical separation modulator is provided on one side, away from the switching wheel 3, of the linearly polarized light synthesis component. The beam combining mirror 4 is configured to converge the modulated light in a plurality of colors and form outgoing light. The projection lens 5 is provided on one side, away from the optical separation modulator, of the beam combining mirror 4.

A working process of the projector of the present disclosure is as follows. White light emitted by the light source 1 passes through the focusing lens 2, which is configured to remove divergent light from white light. Light that passes through the focusing lens 2 passes through the switching wheel 3, which is configured to alternately block light that passes through the focusing lens 2 and transmit light that passes through the focusing lens 2 through the switching wheel 3. And time for blocking light formed by the focusing lens 2 is less than or equal to time for transmitting light formed by the focusing lens 2. The linearly polarized light synthesis component integrates light that passes through the switching wheel 3 into linearly polarized light. The optical separation modulator separates the linearly polarized light into light in a plurality of colors, and separately modulates the light in a plurality of colors, and the modulated light in a plurality of colors is converged by the beam combining mirror 4 to form outgoing light. Finally, the outgoing light is emitted onto a display screen by the projection lens 5. The switching wheel 3 renders the display screen therebehind black by blocking light, so that no light is incident on human eyes within the period. In this way, on the one hand, liquid crystal molecules can be prevented from displaying an image in an intermediate state during switchover between a first frame and a second frame. On the other hand, because black images occur to retinas of human eyes, visual persistence of an image of the first frame on the retinas can be “cut off”. Then, light passes through the switching wheel 3 to make an image of the second frame presented on the final display screen. Such a process can remove the “smear” phenomenon.

In the present disclosure, a type of the light source 1 may be a bulb light source, comprising a metal halide lamp, a high pressure mercury lamp, or a hernia lamp, or a white light source formed by blue laser or LED-excited screen powder, and the light source 1 is not specifically limited herein.

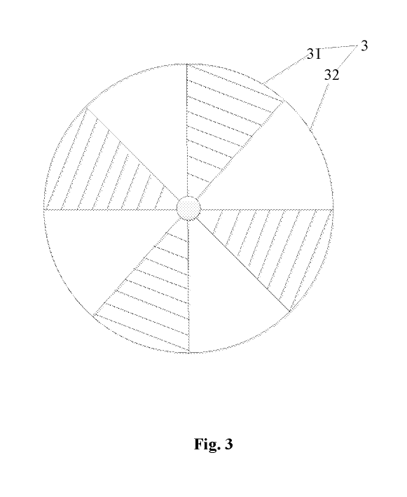

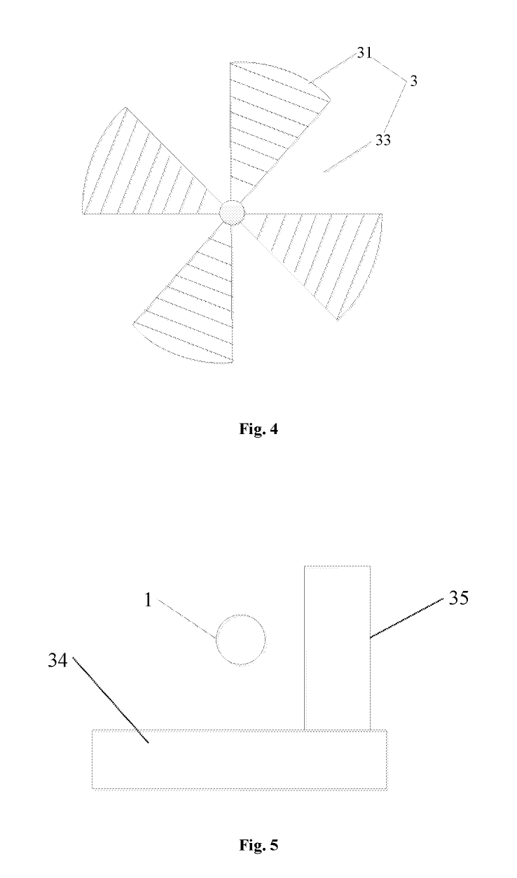

As shown in FIG. 3, in the present disclosure, the switching wheel 3 comprises a plurality of black areas 31 configured to block light and a transparent area 32 for light to pass through which is provided between adjacent two of the black areas 31. An area of the black area 31 is less than or equal to that of the transparent area 32. In an embodiment, the switching wheel 3 comprises a plurality of black areas 31 configured to block light and a blank area 33 for light to pass through which is provided between adjacent two of the black areas 31. An area of the black area 31 is less than or equal to that of the white area 33. A processing manner of the switching wheel 3 is to intermittently coat a black absorbing layer on a transparent substrate, and the black absorbing layer prevents light from passing through the switching wheel 3. The structure is shown in FIG. 3 or FIG. 4. No material is provided in the transparent area 32, namely, the transparent area 32 is the blank area 33. As shown in FIG. 8, there is a relationship between the switching wheel 3 and a switching frequency of chip liquid crystal. When a chip displays the first frame, (that is, an illuminated (N−1)^{th} frame A shown in FIG. 8), outgoing light of the light source 1 is transmitted through the transparent area 32 or the blank area 33 of the switching wheel 3, and finally, light can be incident on the chip, and the chip modulates the light to form the image of the first frame. When the chip displays the image of the second frame, there is a liquid crystal response time t1 between the first frame and the second frame, within which period, the switching wheel 3 rotates by an angle, and the black area 31 blocks light, so that no light is incident on human eyes within the period. In this way, on the one hand, liquid crystal molecules can be prevented from displaying an image in the intermediate state during the switchover between the first frame and the second frame. On the other hand, because a black image occurs to retinas of human eyes, visual persistence of an image of the first frame on the retinas can be “cut off”. In this way, the “smear” phenomenon can be effectively removed. And then the switching wheel 3 rotates for another angle, so that light is located in the transparent area 32 or the blank area 33. In this case, the chip displays the image of the second frame (that is, an illuminated N^{th} frame B shown in FIG. 8). The entire process is shown in FIG. 4, wherein a correspondence exists between the area of the black area 31 and that of the transparent area 32 (or the blank area 33). If a refresh frequency of the display screen is the same as a pixel response time t1 (including a frame addressing time t2), a ratio of the area of the black area 31 to that of the transparent area 32 (or the blank area 33) is ≤1. When the value is equal to 1, the “smear” phenomenon caused by a slow response speed of liquid crystal molecules in the chip and the “smear” phenomenon caused by visual persistence of human eyes are completely removed. If the value is <1, the “smear” phenomenon caused by a slow response speed of liquid crystal molecules in the chip is partially removed, and the “smear” phenomenon caused by visual persistence of human eyes is completely removed.

Certainly, as shown in FIGS. 5 to 7, the switching wheel 3 may also be designed to comprise a translational device 34 and a blocking sheet 35 that slides left and right on the translational device 34. The blocking sheet 35 is located on a light path, and the translational device 34 controls the blocking sheet 35 to move rapidly in left and right directions of the light path. When the chip displays the image of the first frame, the blocking sheet 35 does not block an incident light spot. The blocking sheet 35 blocks the incident light spot in time between the image of the first frame and the image of the second frame. When the second frame is displayed, the incident light spot is not blocked either. An LCD chip or an Lcos chip is used in the present disclosure. Certainly, other chips may also be used, and specific limitation is not made herein.

In the present disclosure, the linearly polarized light synthesis component comprises a polarized light converter 6 and a plurality of shaping optical elements 7. The polarized light converter 6 is provided on one side, away from the focusing lens 2, of the switching wheel 3; and the plurality of shaping optical elements 7 are provided between the polarized light converter 6 and the switching wheel 3. The shaping optical elements 7 are configured to distribute light evenly, and the polarized light converter 6 forms light that is distributed evenly into polarized light.

In the present disclosure, the optical separation modulator comprises an optical separator configured to separate the linearly polarized light into light in three different colors and modulators that respectively modulate the light in three different colors. That is, the optical separation modulator comprises an optical separator configured to separate the linearly polarized light into first light A, second light B, and third light C, and a first optical modulator, a second optical modulator, and a third optical modulator that respectively modulate the first light A, the second light B, and the third light C. In a specific embodiment, the first light A is blue light; the second light B is green light; and the third light C is red light.

In a specific embodiment, the optical separator of the present disclosure comprises a first dichroscope 8 and a second dichroscope 9. The first dichroscope 8 is provided in an inclined manner and is located on one side, away from the switching wheel 3, of the linearly polarized light synthesis component. The second dichroscope 9 is parallel to the first dichroscope 8 and is located on one side, away from the linearly polarized light synthesis component, of the first dichroscope 8. In the present disclosure, the first dichroscope 8 is provided in an inclined manner at 45° relative to a horizontal line, and is located on one side, away from the switching wheel 3, of the polarized light converter 6. The second dichroscope 9 is provided in an inclined manner at 45° relative to the horizontal line, and is located on one side, away from the polarized light converter 6, of the first dichroscope 8. The linearly polarized light is incident on the first dichroscope 8, and the first dichroscope 8 reflects the first light A, and transmits mixed light D of the second light B and the third light. The first light A is modulated by the first optical modulator; the mixed light D of the second light B and the third light C is incident on the second dichroscope 9; the second dichroscope 9 reflects the second light B, and transmits the third light C; the second light B is modulated by the second optical modulator, and the third light C is modulated by the third optical modulator. In the present disclosure, the linearly polarized light is incident on the first dichroscope 8, which reflects blue light and transmits yellow light. That is, in the present disclosure, the blue light is the first light A; the yellow light is the mixed light of the second light B and the third light C. The transmitted yellow light is incident on the second dichroscope 9, which reflects green light and transmits red light. That is, in the present disclosure, the green light is the second light B, and the red light is the third light C.

In the present disclosure, an LCD chip or an Lcos chip is used.

As shown in FIG. 1, when the LCD chip is used, the first optical modulator is a first optical modulation LCD chip 10. In the present disclosure, the first optical modulation LCD chip 10 is a blue light modulation LCD chip. A first reflecting mirror 11 parallel to the first dichroscope 8 is provided above the first dichroscope 8. The first optical modulation LCD chip 10 is provided on one side, close to the second dichroscope 9, of the first reflecting mirror 11 of the present disclosure. In the present disclosure, the first reflecting mirror 11 is provided in an inclined manner at 45° relative to the horizontal line. The blue light is reflected to the blue light modulation LCD chip by the first reflecting mirror 11, and is modulated by the blue light modulation LCD chip. The second optical modulator is a second optical modulation LCD chip 20. In the present disclosure, the second optical modulation LCD chip 20 is a green light modulation LCD chip, and is located above the second dichroscope 9. Green light reflected by the second dichroscope 9 is modulated by the green light modulation LCD chip. A second reflecting mirror 12 parallel to the second dichroscope 9 is provided on one side, away from the first dichroscope 8, of the second dichroscope 9. A third reflecting mirror 13 staggered with the second reflecting mirror 12 is provided above the second reflecting mirror 12, and light formed by reflection of the third reflecting mirror 13 is parallel to light incident on the second reflecting mirror 12. The third optical modulator is a third optical modulation LCD chip 30. Specifically, the third optical modulation LCD chip 30 is provided on one side, close to the second dichroscope 9, of the third reflecting mirror 12. The third optical modulation LCD chip is a red light modulation LCD chip. Red light transmitted by the second dichroscope 9 is modulated by the red light modulation LCD chip after being reflected by the second reflecting mirror 12 and the third reflecting mirror 13. Images modulated by the foregoing three LCD chips are synthesized into one image by the beam combining mirror 4, and light emitted by the beam combining mirror 4 is emitted onto the display screen by a projection lens. In a specific embodiment, the third optical modulation LCD chip 30 is parallel to the first optical modulation LCD chip 10; and the second optical modulation LCD chip 20 is disposed between the first optical modulation LCD chip 10 and the third optical modulation LCD chip 30, and is perpendicular to the first optical modulation LCD chip 10. The beam combining mirror 4 is provided above the second optical modulation LCD chip 20 and is disposed between the first optical modulation LCD chip 10 and the third optical modulation LCD chip 30. By means of the configuration, the beam combining mirror 4 is to synthesize images modulated by three LCD chips into one image. The second reflecting mirror 12 is provided in an inclined manner at 45° relative to the horizontal line, and the third reflecting mirror 13 is provided in an inclined manner at 135° relative to the horizontal line, so that light formed by reflection of the third reflecting mirror 13 is parallel to light incident on the second reflecting mirror 12.

As shown in FIG. 2, when the Lcos chip is used, the first optical modulator comprises a first optical modulation Lcos chip 40 located above the beam combining mirror 4, and a first polarized beam combining mirror 41 provided between the first optical modulation Lcos chip 40 and the beam combining mirror 4. The first reflecting mirror 11 parallel to the first dichroscope 8 is provided on one side, close to the first dichroscope 8, of the first polarized beam combining mirror 41. In the present disclosure, the first optical modulation Lcos chip 40 is a blue light modulation Lcos chip. Blue light reflected by the first dichroscope 8 is reflected to the first polarized beam combining mirror 41 and the blue light modulation Lcos chip by the first reflecting mirror 11 for modulation.

The second optical modulator comprises a second optical modulation Lcos chip 50 provided on one side, close to the second dichroscope 9, of the beam combining mirror 4, and a second polarized beam combining mirror 51 provided between the second optical modulation Lcos chip 50 and the beam combining mirror 4 and located above the second dichroscope 9. The second optical modulation Lcos chip 50 is a green light modulation Lcos chip. Green light reflected by the second dichroscope 9 is incident on the second polarized beam combining mirror 51 and the green light modulation Lcos chip 50 for modulation. The third optical modulator comprises a third optical modulation Lcos chip 60 located below the beam combining mirror 4, and a third polarized beam combining mirror 61 provided between the third optical modulation Lcos chip 60 and the beam combining mirror 4. The third polarized beam combining mirror 61 is located on one side, away from the first dichroscope 8, of the second dichroscope 9. In the present disclosure, the third optical modulation Lcos chip is a red light modulation Lcos chip. Red light transmitted by the second dichroscope 9 is incident on the third polarized beam combining mirror 61 and the red light modulation Lcos chip 60 for modulation. Images modulated by three chips are synthesized by one beam combining mirror 4 into one image, and light emitted by the beam combining mirror 4 is emitted onto the display screen by a projection lens.

As shown in FIG. 8, in the present disclosure, there is a relationship (shown in the time t-image display process relationship diagram in FIG. 8) between the switching wheel 3 and a switching frequency of an LCD chip or an Lcos chip (LCD/Lcos chip in short hereafter). When the LCD/Lcos chip displays the first frame, (that is, an illuminated (N−1)^{th} frame A shown in FIG. 8), outgoing light of the light source 1 is transmitted through the transparent area 32 or the blank area 33 of the switching wheel 3, and finally, light can be incident on the LCD/Lcos chip, which modulates the light to form the image of the first frame. When the LCD/Lcos chip displays the image of the second frame, there is a liquid crystal response time t1 between the first frame and the second frame, within which period, the switching wheel 3 rotates by an angle, and the black area 31 blocks light, so that no light is incident on human eyes within the period. In this way, on the one hand, liquid crystal molecules can be prevented from displaying an image in the intermediate state during the switchover between the first frame and the second frame. On the other hand, because a black image occurs to retinas of human eyes, visual persistence of an image of the first frame on the retinas can be “cut off”. In this way, the “smear” phenomenon can be effectively removed. And then the switching wheel 3 rotates for another angle, so that light is located in the transparent area 32 or the blank area 33. In this case, the LCD/Lcos chip displays the image of the second frame (that is, an illuminated N^{th} frame B shown in FIG. 8). Another process is performed, and the LCD/Lcos chip displays an image of a third frame (that is, an illuminated (N+1)^{th} frame C shown in FIG. 8). The entire process is shown in FIG. 4, wherein a correspondence exists between the area of the black area 31 and that of the transparent area 32 (or the blank area 33). If a refresh frequency of the display screen is the same as a pixel response time t1 (including a frame addressing time t2), a ratio of the area of the black area 31 to that of the transparent area 32 (or the blank area 33) is ≤1. When the value is equal to 1, the “smear” phenomenon caused by a slow response speed of liquid crystal molecules in the LCD/Lcos chip and the “smear” phenomenon caused by visual persistence of human eyes are completely removed. If the value is <1, the “smear” phenomenon caused by a slow response speed of liquid crystal molecules in the chip is partially removed, and the “smear” phenomenon caused by visual persistence of human eyes is completely removed.

By means of the following solution, that is, light that passes through the focusing lens 2 is blocked by the switching wheel 3 and passes through the switching wheel 3 alternately; time for blocking light formed by the focusing lens 2 is less than or equal to time for transmitting light formed by the focusing lens 2; and a specific relationship between the switching wheel 3 and the switching frequency of liquid crystal of the LCD/Lcos chip is designed, the present disclosure removes the “smear” phenomenon. That is, the “smear” phenomenon caused by a slow liquid crystal response speed in an LCD/Lcos chip (including a DMD chip with a fast response speed) and a visual persistence phenomenon of human eyes can be reduced, so as to improve image quality and increase viewing experience effects.

Although the present disclosure has been described with reference to preferred embodiments, various improvements can be made on the present disclosure, and components of the present disclosure can be replaced with equivalents without departing from the scope of the present disclosure. In particular, as long as there is no structural conflict, various technical features mentioned in the embodiments can be combined arbitrarily. The present disclosure is not limited to specific embodiments disclosed in the specification, but instead, comprises all technical solutions that fall into the scope of claims.

### LIST OF REFERENCE NUMBERS

1—Light source;
2—Focusing lens;
3—Switching wheel;
31—Black area;
32—Transparent area;
33—Blank area;
34—Translational device;
35—Blocking sheet;
4—Beam combining mirror;
5—Projection lens;
6—Polarized light converter;
7—Shaping optical element;
8—First dichroscope;
9—Second dichroscope;
10—First optical modulation LCD chip;
11—First reflecting mirror;
12—Second reflecting mirror;
13—Third reflecting mirror;
20—Second optical modulation LCD chip;
30—Third optical modulation LCD chip;
40—First optical modulation Lcos chip;
41—First polarized beam combining mirror;
50—Second optical modulation Lcos chip;
51—Second polarized beam combining mirror;
60—Third optical modulation Lcos chip;
61—Third polarized beam combining mirror;
t—Time;
t1—Pixel corresponding time;
t2—Addressing time;
A—Illuminated (N−1)^{th} frame;
B—Illuminated N^{th} frame; and
C—Illuminated (N+1)^{th} frame.

1. A projector, wherein the projector comprises:
a light source;
a focusing lens provided on one side of the light source;
a switching wheel configured to alternately block or transmit light formed by the focusing lens, wherein time for blocking light formed by the focusing lens is less than or equal to time for transmitting light formed by the focusing lens, and the switching wheel is provided on one side, away from the light source, of the focusing lens;
a linearly polarized light synthesis component configured to form light transmitted through the switching wheel into linearly polarized light, wherein the linearly polarized light synthesis component is provided on one side, away from the focusing lens, of the switching wheel;
an optical separation modulator configured to separate the linearly polarized light into light in a plurality of colors and modulate the separated light in a plurality of colors, wherein the optical separation modulator is provided on one side, away from the switching wheel, of the linearly polarized light synthesis component;
a beam combining mirror configured to converge the modulated light in a plurality of colors and form outgoing light; and
a projection lens provided on one side, away from the optical separation modulator, of the beam combining mirror.

2. The projector according to claim 1, wherein the linearly polarized light synthesis component comprises:
a polarized light converter provided on one side, away from the focusing lens, of the switching wheel,
wherein a plurality of shaping optical elements are provided between the polarized light converter and the switching wheel.

3. The projector according to claim 1, wherein the optical separation modulator comprises an optical separator configured to separate first light, second light, and third light; and a first optical modulator, a second optical modulator, and a third optical modulator that respectively modulate the first light, the second light, and the third light.

4. The projector according to claim 3, wherein the optical separator comprises a first dichroscope and a second dichroscope,
wherein the first dichroscope is provided in an inclined manner and is located on one side, away from the switching wheel, of the linearly polarized light synthesis component, and
wherein the second dichroscope is provided parallel to the first dichroscope and is located on one side, away from the linearly polarized light synthesis component, of the first dichroscope.

5. The projector according to claim 4, wherein the first optical modulator is a first optical modulation LCD chip;
wherein a first reflecting mirror parallel to the first dichroscope is provided above the first dichroscope; and
wherein the first optical modulation LCD chip is provided on one side, close to the second dichroscope, of the first reflecting mirror.

6. The projector according to claim 5, wherein the second optical modulator is a second optical modulation LCD chip, which is located above the second dichroscope;
wherein a second reflecting mirror parallel to the second dichroscope is provided on one side, away from the first dichroscope, of the second dichroscope;
wherein a third reflecting mirror staggered with the second reflecting mirror is provided above the second reflecting mirror, and light formed by reflection of the third reflecting mirror is parallel to light incident on the second reflecting mirror;
wherein a third optical modulation LCD chip parallel to the first optical modulation LCD chip is provided on one side, close to the second dichroscope, of the third reflecting mirror;
wherein the second optical modulation LCD chip is disposed between the first optical modulation LCD chip and the third optical modulation LCD chip and is perpendicular to the first optical modulation LCD chip; and
wherein the beam combining mirror is provided above the second optical modulation LCD chip and is located between the first optical modulation LCD chip and the third optical modulation LCD chip.

7. The projector according to claim 4, wherein the first optical modulator comprises a first optical modulation Lcos chip located above the beam combining mirror and a first polarized beam combining mirror provided between the first optical modulation Lcos chip and the beam combining mirror, and
wherein a first reflecting mirror parallel to the first dichroscope is provided on one side, close to the first dichroscope, of the first polarized beam combining mirror.

8. The projector according to claim 7, wherein the second optical modulator comprises: a second optical modulation Lcos chip provided on one side, close to the second dichroscope, of the beam combining mirror, and a second polarized beam combining mirror provided between the second optical modulation Lcos chip and the beam combining mirror and located above the second dichroscope; and
wherein the third optical modulator comprises: a third optical modulation Lcos chip located below the beam combining mirror, and a third polarized beam combining mirror provided between the third optical modulation Lcos chip and the beam combining mirror and located on one side, away from the first dichroscope, of the second dichroscope.

9. The projector according to claim 1, wherein the switching wheel comprises a plurality of black areas configured to block light, and a transparent area or blank area for light to pass through which is provided between adjacent two of the black areas; and
wherein an area of the black area is less than or equal to that of the transparent area or the white area.

10. The projector according to claim 1, wherein the switching wheel comprises a translational device, and a blocking sheet that moves left and right on the translational device to block or transmit light.
